(19) United States
(12) Patent Application Publication
(10) Pub. No.: US 2026/0238979 A1
(43) Pub. Date: Aug. 13, 2026

(54) METHODS, SYSTEMS, AND DEVICES FOR A VEHICLE EMERGENCY MESSAGE DELIVERY SYSTEM

(71) Applicant: Toyota Motor Engineering & Manufacturing North America, Inc., Plano, TX (US)

(72) Inventors: Dogan Kutay Pekcan, Irvine, CA (US); Chinmay S. Mahabal, San Jose, CA (US); Takayuki Shimizu, Santa Clara, CA (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 19/053,256

(22) Filed: Feb. 13, 2025

(51) Int. Cl. H04W 4/90; H04W 4/029; H04W 4/40; H04W 84/06

(52) U.S. Cl. CPC H04W 4/90; H04W 4/029; H04W 4/40; H04W 84/06

(57) ABSTRACT

Methods, systems, and devices for an emergency message delivery system for a vehicle. The system may include a first network access device of a first vehicle configured to transmit and receive a vehicle emergency message. The system may include a second network access device of a second vehicle configured to transmit and receive the vehicle emergency message. The system may include an electronic control unit (ECU). The ECU may receive a signal indicating an emergency has occurred, generate a vehicle emergency message, transmit the vehicle emergency message to emergency services via cellular connectivity, transmit the vehicle emergency message to emergency services via satellite connectivity, when both transmissions have failed, transmit the vehicle emergency message to the second network access device of the second vehicle to allow the second network access device to deliver the vehicle emergency message to emergency services, and receive confirmation of delivery of the vehicle emergency message.

### BACKGROUND

### 1. Field

The present disclosure relates to methods, systems, and/or devices for a vehicle emergency message delivery system to enhance safety.

### 2. Description of the Related Art

Current devices may include systems or methods for sending an emergency message when an emergency scenario has occurred. The current devices may use cellular networks, satellite technology, or communication between vehicles and/or devices (e.g., smart phone) to send the emergency message. For example, the current devices may include a mechanism for activating an emergency signal via satellite when a user is in an area with no cellular or Wi-Fi coverage. However, the current devices are generally not able to integrate the various communication modes together to effectively deliver an emergency message.

Accordingly, it is desirable to provide improved methods, systems, and devices for a vehicle emergency message delivery system.

### SUMMARY

In general, one aspect of the subject matter described in this disclosure may be embodied in an emergency message delivery system for a vehicle. The system may include a first network access device of a first vehicle configured to transmit and receive a vehicle emergency message. The system may include a second network access device of a second vehicle configured to transmit and receive the vehicle emergency message. The system may include an electronic control unit (ECU). The ECU may be configured to (1) receive a triggering signal indicating an emergency has occurred, (2) generate a vehicle emergency message having information about the first vehicle and passengers including a location of the first vehicle, current status of the vehicle emergency message, and vehicle identification data about the first vehicle, (3) transmit the vehicle emergency message to emergency services via cellular connectivity, (4) transmit the vehicle emergency message to emergency services via satellite connectivity when the transmission of the vehicle emergency message via cellular connectivity fails, (5) when both transmissions have failed, transmit the vehicle emergency message to the second network access device of the second vehicle via the first network access device to allow the second network access device to deliver the vehicle emergency message to emergency services using satellite or cellular connectivity, and (6) receive confirmation of delivery of the vehicle emergency message to emergency services from the second vehicle.

In one aspect, the subject matter may be embodied in a method for generating and transmitting a vehicle emergency message. The method may include receiving a triggering signal indicating an emergency has occurred. The method may further include in response to receiving the triggering signal, generating a vehicle emergency message having information about a first vehicle and passengers including a location of the first vehicle, current status of the vehicle emergency message, and vehicle identification data about the first vehicle. The method may further include transmitting the vehicle emergency message to emergency services via cellular connectivity. The method may further include transmitting the vehicle emergency message to emergency services via satellite connectivity when the transmission of the vehicle emergency message via cellular connectivity fails. The method may further include when both transmissions have failed, transmitting the vehicle emergency message to the second network access device of the second vehicle via the first network access device to allow the second network access device to deliver the vehicle emergency message to emergency services using satellite or cellular connectivity. The method may further include receiving confirmation of delivery of the vehicle emergency message to emergency services from the second vehicle.

In one aspect, the subject matter may be embodied in a vehicle including a system for generating and transmitting a vehicle emergency message. The vehicle may include a first network access device configured to transmit and receive a vehicle emergency message. The vehicle may further include an ECU configured to (1) receive a triggering signal indicating an emergency has occurred, (2) in response to receiving the triggering signal, generate a vehicle emergency message having information about the vehicle and passengers including a location of the first vehicle, current status of the vehicle emergency message, and vehicle identification data about the first vehicle, (3) transmit the vehicle emergency message to emergency services via cellular connectivity, (4) transmit the vehicle emergency message to emergency services via satellite connectivity when the transmission of the vehicle emergency message via cellular connectivity fails, (5) when both transmissions have failed, transmit the vehicle emergency message to a second network access device of a second vehicle via the first network access device to allow the second network access device to deliver the vehicle emergency message to emergency services using satellite or cellular connectivity, and (6) receive confirmation of delivery of the vehicle emergency message to emergency services from the second vehicle.

### BRIEF DESCRIPTION OF THE DRAWINGS

Other systems, methods, features, and advantages of the present disclosure will be apparent to one skilled in the art upon examination of the following figures and detailed description. Component parts shown in the drawings are not necessarily to scale and may be exaggerated to better illustrate the important features of the present disclosure. In the drawings, like reference numerals designate like parts throughout the different views.

FIG. 1 is a block diagram of an example emergency message delivery system for a vehicle according to an aspect of the disclosure.

FIG. 2 illustrates a plurality of vehicles implementing the emergency message delivery system of FIG. 1 according to an aspect of the disclosure.

FIG. 3 is a flow diagram of a first example process for the emergency message delivery system of FIG. 1 according to an aspect of the disclosure.

FIG. 4 is a flow diagram of a second example process for the emergency message delivery system of FIG. 1 according to an aspect of the disclosure.

FIG. 5 is a flow diagram of a third example process for the emergency message delivery system of FIG. 1 according to an aspect of the disclosure.

### DETAILED DESCRIPTION

Disclosed herein are methods, systems, devices, and/or vehicles for implementing an emergency message delivery system. The emergency message delivery system may deliver emergency messages by leveraging vehicular communications with other possible connectivity types (e.g., cellular or non-terrestrial networks (NTN)). The emergency message delivery system may also gather emergency message content to generate a vehicle emergency message (VEM). The emergency message delivery system can utilize direct vehicle-to-everything (V2X) mechanisms with multi-hop relay communication together with integrated terrestrial/non-terrestrial networks (TN/NTN) connectivity for emergency message delivery. The emergency message delivery system may combine the potential of TN/NTN connectivity in remote areas and the network-free direct V2X connectivity between vehicles whenever TN/NTN connectivity is unavailable. Therefore, the vehicle may attempt to send an emergency message via TN/NTN connectivity, and in the case this fails, the vehicle can send the emergency message to another vehicle via V2X, which can then attempt to deliver the message to emergency services. In this way, the emergency message delivery system can make nearby vehicles responsible for the emergency message delivery to boost the likelihood of message delivery.

The emergency message delivery system may include radio and software installed in a source node (e.g., the vehicle experiencing the emergency) and relay node(s) (e.g., another vehicle, road-side unit, base station, smartphone, mobile device) for delivering emergency messages in out-of-coverage scenarios, by taking advantage of vehicular communications, together with TN/NTN connectivity. Therefore, the emergency message delivery system can combine direct V2X with any type of available connectivity to deliver an emergency message, whenever there is an in-vehicle or near-vehicle emergency while travelling.

Particular aspects or embodiments of the subject matter described in this disclosure may be implemented to realize one or more of the following advantages. Emergency scenarios are particularly challenging to deal with in the remote areas due to lack of connectivity. In particular, rural areas with sparse populations have a much smaller number of cell towers and provide minimal coverage. The system described herein can provide a Vehicle Emergency Message (VEM) containing detailed message contents and may be adaptive across different networks to make contacting emergency services more reliable. The system described herein may also provide a method and apparatus for delivering this message in out-of-coverage scenarios, by taking advantage of vehicular communications, together with TN/NTN connectivity. The emergency message delivery system can generate independent chains for relaying the emergency message with the VEM at a first relay node (e.g., vehicle), and can exploit other vehicles that are moving in different directions and significantly increase the probability to deliver the emergency message. In addition, the emergency message delivery system can extend the coverage area of message delivery by using vehicles for emergency signaling. When the vehicle and the user are in a remote area, the relay node of the emergency message delivery system can take the responsibility of the VEM and deliver it in an area where there is coverage (e.g., via a subsequent vehicle using V2X).

The system may include a first network access device of a first vehicle configured to transmit and receive a vehicle emergency message. The system may include a second network access device of a second vehicle configured to transmit and receive the vehicle emergency message. The system may include an electronic control unit (ECU). The ECU may receive a triggering signal indicating an emergency has occurred, generate a vehicle emergency message having information about the first vehicle and passengers including a location of the first vehicle, current status of the vehicle emergency message, and vehicle identification data about the first vehicle, transmit the vehicle emergency message to emergency services via cellular connectivity, transmit the vehicle emergency message to emergency services via satellite connectivity when the transmission of the vehicle emergency message via cellular connectivity fails, when both transmissions have failed, transmit the vehicle emergency message to the second network access device of the second vehicle via the first network access device to allow the second network access device to deliver the vehicle emergency message to emergency services using satellite or cellular connectivity, and receive confirmation of delivery of the vehicle emergency message to emergency services from the second vehicle.

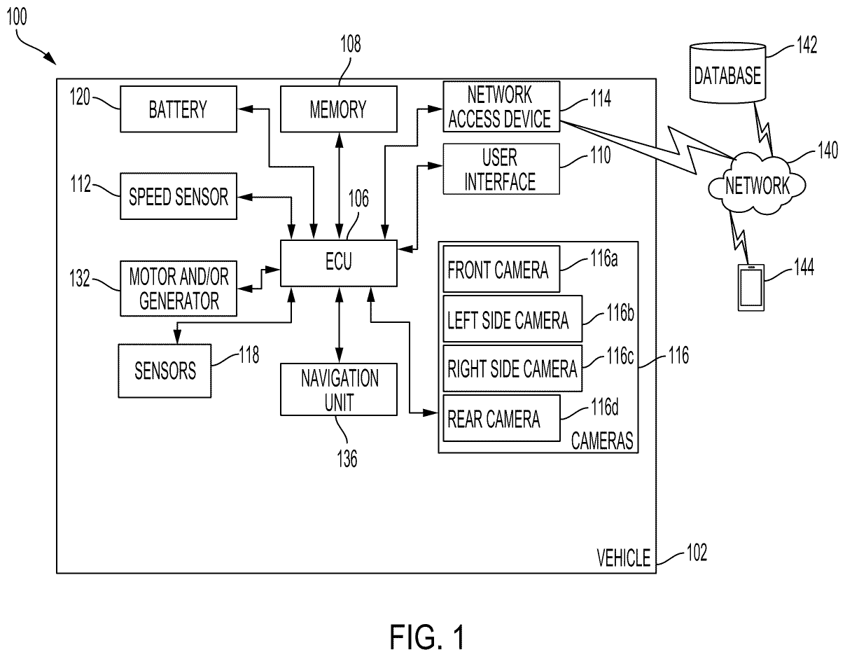

FIG. 1 is a block diagram for an example emergency message delivery system 100. The emergency message delivery system 100 or a portion thereof may be retrofitted, coupled to, include, or be included within a vehicle 102 or separate from the vehicle 102. The vehicle 102 may be a conveyance capable of transporting a person, an object, or a permanently or temporarily affixed apparatus. The vehicle 102 may be a self-propelled wheeled conveyance, such as a car, a sports utility vehicle, a truck, a bus, a van, a motorcycle, or other motor, battery, or fuel cell driven vehicle. For example, the vehicle 102 may be an electric vehicle, a hybrid vehicle, a plug-in hybrid vehicle, a hydrogen fuel cell vehicle, or any other type of vehicle that has a fuel cell, a motor, an engine, and/or a generator. Other examples of vehicles include bicycles, trains, planes, or boats, and any other form of conveyance that is capable of transportation. The vehicle 102 may be semi-autonomous or autonomous. That is, the vehicle 102 may be self-maneuvering and navigate without human input. An autonomous vehicle may have and use one or more sensors and/or a navigation unit to drive autonomously.

The emergency message delivery system 100 and/or the vehicle 102 may include a motor and/or generator 132 and/or a battery 120. The motor and/or generator 132 may be located within an engine bay of the vehicle 102. For example, the motor and/or generator 132 may be an internal combustion engine (ICE). In this regard, the motor and/or generator 132 may combust an air and fuel mixture to provide power to the vehicle 102 and/or components of the vehicle 102 and/or the emergency message delivery system 100. Accordingly, the motor and/or generator 132 can cause the vehicle 102 to accelerate, decelerate, or maintain a desired velocity. The motor and/or generator 132 may include combinations of an ICE and an electric motor, such as for hybrid electric vehicle (HEV) applications, for example. In examples, the motor and/or generator 132 may be an electric motor, such as for battery electric vehicle (BEV) applications, for example. In this regard, the motor and/or generator 132 may be an electric motor and an electric generator that converts electrical energy into mechanical power, such as torque, and converts mechanical power into electrical energy. The motor and/or generator 132 may be electrically connected to the battery 120. The motor and/or generator 132 may convert energy from the battery 120 into mechanical power, and may provide energy back to the battery 120, for example, via regenerative braking. The battery 120 may be electrically connected to the motor and/or generator 132 and may provide electrical energy to and/or receive electrical energy from the motor and/or generator 132. The battery 120 may provide electrical energy to the emergency message delivery system 100.

The emergency message delivery system 100 and/or the vehicle 102 may further include one or more processors, such as an electronic control unit (ECU) 106. The ECU 106 may be implemented as a single ECU or in multiple ECUs. The ECU 106 may be electrically connected to some or all of the components of the vehicle 102 and/or the emergency message delivery system 100 (e.g., via a controller area network (CAN) bus and/or other protocols). For example, the ECU 106 may be electrically connected to the motor and/or generator 132, the battery 120, a memory 108, a user interface 110, a network access device 114, a navigation unit 136, a speed sensor 112, one or more cameras 116, and/or one or more sensors 118. The ECU 106 may include one or more processors (or controllers) specifically designed for controlling operations of the vehicle 102, such as accelerating, braking, autonomous driving, parking (or parking assistance), etc. Moreover, the ECU 106 may control a panoramic view monitor (PVM) of the vehicle 102 (e.g., including the user interface 110, the one or more cameras 116, and/or the one or more sensors 118). In examples, the ECU 106 may be and/or include an advanced driver assistance systems (ADAS) sensor fusion ECU, a PVM ECU, an engine control module (ECM), a transmission control module (TCM), a telematics control unit (TCU), an inertial measurement unit (IMU), an in-vehicle infotainment (IVI) ECU, and/or a graphics processing unit (GPU).

The emergency message delivery system 100 may further include the memory 108. The memory 108 may be electrically connected to the ECU 106. In examples, the memory 108 may be communicatively coupled (e.g., via a network 140 and/or the network access device 114) to the ECU 106 such that the memory 108 is remote from the ECU 106 and/or the vehicle 102. In other examples, the memory 108 may be electrically connected to the ECU 106 and a remote memory (e.g., a remote database 142) may be communicatively coupled to the ECU 106, with the remote memory having similar, additional, and/or different functions as the memory 108 (e.g., greater storage capacity, enabling over-the-air updates, etc.). The memory 108 may store instructions to execute on the ECU 106 and may include one or more of a random access memory (RAM) or other volatile or non-volatile memory. The memory 108 may be a non-transitory memory or a data storage device, such as a hard disk drive, a solid-state disk drive, a hybrid disk drive, or other appropriate data storage, and may further store machine-readable instructions, which may be loaded and executed by the ECU 106. The memory 108 may store vehicle parameters (e.g., a weight of the vehicle 102, dimensions of the vehicle 102, transmission gear information of the vehicle 102, etc.).

The emergency message delivery system 100 may further include the user interface 110. The user interface 110 may be located within a cabin of the vehicle 102 (e.g., coupled to a dashboard of the vehicle 102). The user interface 110 may provide an interface to a user of the vehicle 102 (e.g., a driver and/or a passenger of the vehicle 102) to interact with and/or receive output from the ECU 106. The user interface 110 may have a user interface element, such as a screen and/or a touchscreen with a button, a switch, a microphone, a speaker, a gesture monitoring sensor, a knob, a graphical user interface (GUI), and/or other input/output devices electrically connected to the ECU 106 to provide input and/or output of information (or data) to and/or from the ECU 106.

The emergency message delivery system 100 may further include the network access device 114. The network access device 114 may be electrically connected to the ECU 106 and may include a communication port or channel, such as one or more of a Wi-Fi unit, a Bluetooth® unit, a Radio Frequency Identification (RFID) tag or reader, a Dedicated Short Range Communications (DSRC) unit, a satellite network unit, and/or a cellular network unit for accessing the network 140 (e.g., CDMA, GSM, 3G, 4G, 5G, etc.). The network access device 114 may transmit data to and receive data from devices and systems not directly connected to the vehicle 102. For example, the ECU 106 may communicate with the remote database 142, a user device 144 (e.g., a mobile device, a phone, a tablet, a laptop, a vehicle, etc.), other vehicles, and/or emergency services through the network access device 114.

The network access device 114 may transmit data to and receive data from other databases 142, for example using vehicle-to-vehicle (V2V) communication, vehicle-to-everything (V2X), and/or vehicle-to-infrastructure (V2I). For example, emergency message delivery system 100 can enable vehicle 102 to exchange vehicle data with a second vehicle using V2V communication technology. The emergency message delivery system 100 can receive location data such as traffic congestion, weather advisories, bridge clearance levels, traffic light status, and/or crime data to inform the emergency message delivery system 100 of conditions at or near the location of the vehicle 102 or a location where the vehicle 102 is headed using V2I and/or V2X communication technology. Accordingly, the vehicle 102 may communicate with another vehicle or a network using vehicle-to-vehicle communications or vehicle-to-infrastructure communications via the network access device 114.

The emergency message delivery system 100 may further include the navigation unit 136. The navigation unit 136 may be electrically connected to the ECU 106 and may provide vehicle information (or data) and/or navigational map information to the ECU 106. The navigation unit 136 may include and/or be connected to a Global Positioning System (GPS) device. The vehicle information may include a current position and/or location of the vehicle 102, a current time at the current position, a direction of travel, and/or a current speed of the vehicle 102. In examples, the navigation unit 136 may provide the vehicle information (e.g., indicating the current speed of the vehicle 102) to the ECU 106. The ECU 106 and/or the navigation unit 136 may determine the current speed of the vehicle 102 (e.g., in miles per hour (MPH) and/or kilometers per hour (KPH)) based on the vehicle information.

The emergency message delivery system 100 may further include the speed sensor 112. In examples, the emergency message delivery system 100 may include a plurality of speed sensors. The speed sensor 112 may be electrically connected to the ECU 106. The speed sensor 112 may be configured to measure, detect, and/or determine the current speed of the vehicle 102. For example, the speed sensor 112 may be and/or include an electronic vehicle speed sensor (e.g., that measures rotation of the motor and/or generator 132 and/or a transmission shaft of the vehicle 102) and/or one or more wheel speed sensors (e.g., that measure rotation of one or more wheels of the vehicle 102). In examples, the speed sensor 112 may provide speed data indicating the current speed of the vehicle 102 to the ECU 106. The ECU 106 and/or the speed sensor 112 may determine the current speed of the vehicle 102 (e.g., in miles per hour (MPH) and/or kilometers per hour (KPH)) based on the speed data.

The emergency message delivery system 100 may further include the one or more cameras 116. The one or more cameras 116 may be coupled to an exterior of the vehicle 102 and/or an interior of the vehicle 102 such that the one or more cameras 116 look out toward a surrounding area of the vehicle 102. The one or more cameras 116 may be and/or include one or more of an analog camera, a digital camera, a thermal camera, and/or a night vision camera (e.g., utilizing active illumination and/or image intensification). The one or more cameras 116 may provide, capture, and/or record images and/or real-time video of the surrounding area of the vehicle 102. In examples, the one or more cameras 116 (e.g., via the ECU 106) may also have pattern recognition capabilities to view the surrounding area and identify, for example, vehicles, components of vehicles (e.g., a license plate, a side view mirror, etc.), road signs (e.g., speed limit signs), and/or writing (e.g., letters, numbers, symbols, etc.) on the vehicles and/or the road signs. The one or more cameras 116 may include one or more front cameras 116a, one or more left side cameras 116b, one or more right side cameras 116c, and/or one or more rear cameras 116d.

The one or more front cameras 116a may be coupled to a front end of the vehicle 102, such as a front bumper and/or a windshield, for example. In examples, the one or more front cameras 116a may include a plurality of front cameras (e.g., with each having a different field of view, orientation, and/or location on the vehicle 102). The one or more front cameras 116a may provide, capture, and/or record real-time video of a forward field of view with respect to the vehicle 102 (e.g., a portion of the surrounding area of the vehicle 102 that is in front of the vehicle 102).

The one or more left side cameras 116b may be coupled to a left side of the vehicle 102, such as a left side mirror, a left front quarter panel (or fender), a left rear quarter panel (or fender), a left side door, etc. In examples, the one or more left side cameras 116b may include a plurality of left side cameras (e.g., with each having a different field of view, orientation, and/or location on the vehicle 102). The one or more left side cameras 116b may provide, capture, and/or record real-time video of a leftward field of view with respect to the vehicle 102 (e.g., a portion of the surrounding area of the vehicle 102 that is to the left of the vehicle 102).

The one or more right side cameras 116c may be coupled to a right side of the vehicle, such as a right side mirror, a right front quarter panel (or fender), a right rear quarter panel (or fender), a right side door, etc. In examples, the one or more right side cameras 116c may include a plurality of right side cameras (e.g., with each having a different field of view, orientation, and/or location on the vehicle 102). The one or more right side cameras 116c may provide, capture, and/or record real-time video of a rightward field of view with respect to the vehicle 102 (e.g., a portion of the surrounding area of the vehicle 102 that is to the right of the vehicle 102).

The one or more rear cameras 116d may be coupled to a rear end of the vehicle 102, such as a rear bumper, a rear window, a tailgate, and/or a liftgate, for example. In examples, the one or more rear cameras 116d may include a plurality of rear cameras (e.g., with each having a different field of view, orientation, and/or location on the vehicle 102). The one or more rear cameras 116d may provide, capture, and/or record real-time video of a rearward field of view with respect to the vehicle 102 (e.g., a portion of the surrounding area of the vehicle 102 that is behind the vehicle 102).

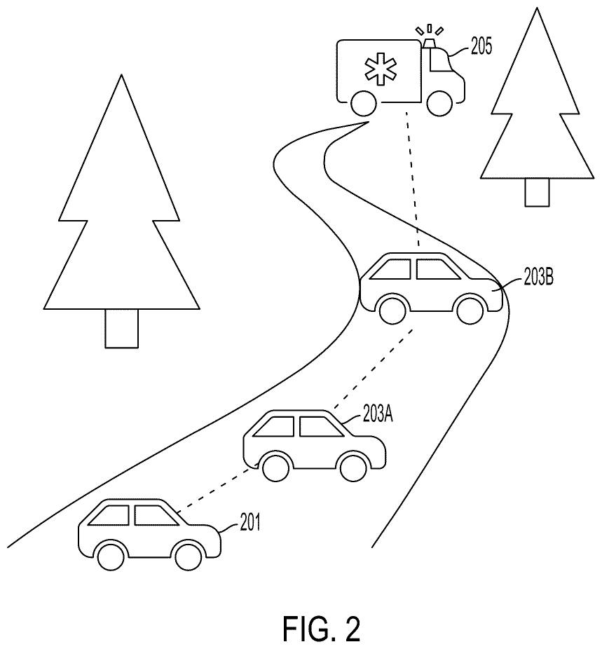

The emergency message delivery system 100 may further include the one or more sensors 118. The one or more sensors 118 may be and/or include one or more of a camera, a radar sensor, an ultrasonic sensor, a lidar sensor, a brake pedal sensor, an accelerator pedal sensor, a GPS, or any other suitable device. The one or more sensors 118 may measure, detect, and/or determine information (or data) of source vehicle 201 and/or one or more target vehicles 203A and 203B (marked in FIG. 2). For example, the one or more sensors 118 may periodically or continuously scan (or monitor) the surrounding area of the vehicle 102 to measure, detect, and/or determine spatial information. The spatial information may be radar data, lidar data, ultrasonic data, and/or image (or video) data, for example. The spatial information may include and/or indicate a position, a direction, and/or a velocity of the one or more target vehicles 203A and 203B relative to the source vehicle 201 at one or more points in time and/or over one or more periods of time. A location of each of the one or more sensors 118 on the source vehicle 201 may be known to the ECU 106 (e.g., the location of each of the one or more sensors 118 may be stored on the memory 108).

In examples where the one or more sensors 118 include one or more cameras (e.g., the one or more cameras 116), the emergency message delivery system 100 may use monocular and/or binocular depth estimation on image (or video) data captured or recorded by the one or more sensors 118 to determine the spatial information.

The one or more sensors 118 may further collect data related to the vehicle 102 and any passengers inside the vehicle. For example, the one or more sensors 118 may collect images from inside the vehicle or seat sensor data that may indicate the number of passengers inside the vehicle. As another example, a GPS sensor may indicate the location of the vehicle.

FIG. 2 illustrates a plurality of vehicles implementing the emergency message delivery system 100 of FIG. 1 according to an aspect of the disclosure. The emergency message delivery system 100 may include a source vehicle 201, target vehicles 203A and 203B, and emergency services 205. The source vehicle 201 may be the vehicle in which an emergency situation occurs. While the examples of source vehicles in this disclosure may relate to ground vehicles, any type of vehicles capable of moving along the land, sea, air, or space can be used (e.g., a car, bus, truck, motorcycle, ship, boat, yacht, aircraft, unmanned aerial vehicle, urban air mobility vehicle).

A vehicle emergency message (VEM) may be generated at the source vehicle 201 (e.g., via an ECU of the source vehicle 201). The target vehicles 203A and 203B may be one or more vehicles which may receive the VEM generated at the source vehicle 201. One or more of the target vehicles 203A and 203B can then send the VEM to the emergency services 205, as further described below.

When the source vehicle 201 is experiencing an emergency (e.g., driver is experiencing a life-threatening medical condition, vehicle is malfunctioning, vehicle is stuck in an unsafe place or location, etc.), the ECU of the source vehicle 201 can generate the VEM. The VEM may contain various types of data detailing information about the vehicle and passengers, current status of the VEM, details of the emergency, data about the vehicle, etc. The contents of VEM can be categorized in three main parts for practicality: vehicle information data (e.g., hard coded data), gatherable data, and editable data. Examples of vehicle information data may include vehicle brand, model, identification number, and/or color and automated driving capability, which may be hard coded to the vehicle. Examples of gatherable data may include location, number of passengers, type of emergency, (e.g., medical or security, such as burglary, breaking and entering, hijacking on the road, vehicle malfunction, flat tire, etc.), current driving mode, (e.g., L1, L2, L3, L4, or so that was in use during the creation of VEM), current range, miles per gallon (MPG), state of charge, medical data of passengers, vehicle is stopping or en route to destination (for automated vehicles), vehicle ID/last assigned ID by the network for the vehicle, cellphone number/last assigned ID by the network (if available) for the user cell phone, mode selection for relay nodes, and supported connectivity capabilities (e.g., TN, NTN, V2X, etc.). Examples of editable data may include whether the VEM is from the source vehicle 201 or not, or the number of hops the VEM has made from the source vehicle 201 (e.g., how many vehicles has this VEM travelled to before the current vehicle).

The source vehicle 201 can collect the available gatherable data. In one aspect, the ECU of the source vehicle 201 can collect the available data from, as examples, one or more sensors associated with the vehicle, one or more cameras associated with the vehicle, etc. For instance, the one or more cameras may detect from image data how many passengers are in the vehicle or the one or more sensors may be a GPS sensor that can determine the current location of the vehicle. After collecting available gatherable data, the source vehicle 201 can embed each component of the data to the VEM, along with the vehicle information data and the editable data. Therefore, the VEM may contain any vehicle information data about the vehicle, any data gathered by the ECU, and whether the VEM is from the source vehicle 201 or not, or the number of hops the VEM has made from the source vehicle 201.

Once the VEM is generated, the source vehicle 201 can send the VEM to the target vehicle 203A. However, this is not meant to be limiting or required. The source vehicle 201 can send the VEM to multiple target vehicles and/or emergency services. In one aspect, the source vehicle 201 may also send the VEM to the target vehicle 203B, in addition to target vehicle 203A. In other aspects, the target vehicle 203A may send the VEM to the target vehicle 203B or the source vehicle 201 may send the VEM to the target vehicle 203B and not to target vehicle 203A. In other aspects, the source vehicle 201 and/or the target vehicles 203A and 203B may send the VEM to other devices, such as a cell phone, laptop, or other device capable of TN/NTN connectivity.

The VEM can be delivered to the target vehicles 203A and 203B using various connectivity modes. The various connectivity modes may include TN Connectivity (e.g., Cellular Networks), NTN Connectivity (e.g., Satellite), or V2X Connectivity. TN may include cellular networks, such as LTE, 3G, 4G, and 5G. TN may use radio waves to send and receive data between terrestrial or Earth-based transmitters and receivers. TN connectivity may be considered as a primary mode in case of emergency scenarios. However, it is not a reliable solution in the areas with no or weak coverage.

NTN connectivity may a use satellites to provide internet access. By using satellites, NTNs can extend network coverage beyond the ground-based cell towers and help to enable connectivity in remote areas where TNs are unavailable. NTN connectivity is a promising technology for emergency message delivery, especially in remote areas with no cell coverage. While the examples of NTN in this disclosure relate to satellite systems, any NTN system can be used for the emergency message delivery system 100 described herein (e.g., Low Earth Orbit (LEO) satellites, Medium Earth Orbit (MEO) satellites, Geostationary Equatorial Orbit (GEO) satellites, High Altitude Platforms Station (HAPS), Uncrewed Aerial Vehicles (UAV)).

V2X may be a wireless communication technology that can enable a vehicle to exchange data with other vehicles or devices. V2X can enable direct communication between vehicles and other entities inside/outside the network coverage and has the potential to enable relaying messages through nearby vehicles to emergency services. The methods and apparatus in this disclosure can be applied to any TN/NTN/V2X communication systems, for example, existing 3GPP radio access technologies (e.g., LTE, 3G, 4G, 5G technologies, future 3GPP radio technologies such as 6G, and future Institute of Electrical and Electronics Engineers (IEEE) 802.11 family technologies).

Using V2X connectivity, the target vehicles 203A or 203B can receive the VEM from the source vehicle 201. The target vehicles 203A and 203B may include a relay node to receive the VEM from the source vehicle 201. The relay node may also be used to send the VEM from the target vehicles 203A and 203B to emergency services 205 or to additional target vehicles. Relay nodes can be any type of wireless network nodes (e.g., vehicle, road-side unit, base station, smartphone, mobile device).

In one aspect, the emergency message delivery system 100 may identify nearby vehicles to send the VEM using spatial information. For example, as the one or more target vehicles 203A and 203B pass the source vehicle 201, spatial information may indicate when the one or more target vehicles 203A and 203B entered a sensor detection zone. The ECU 106 may determine when the one or more target vehicles 203A and 203B entered the sensor detection zones based on the spatial information (e.g., radar data, lidar data, ultrasonic data, and/or image (or video) data) received from the one or more sensors 118.

Moreover, in examples, the one or more sensors 118 may determine a distance between the vehicle 102 and the one or more target vehicles 203A and 203B at each instance of the one or more target vehicles 203A and 203B entering the sensor detection zone. This may be used by the ECU 106 to determine a distance traveled by the one or more target vehicles 203A and 203B within the determined one or more periods of time. The ECU 106 may then determine the one or more target vehicles 203A and 203B are within range to send the VEM.

In examples, the one or more sensors 118 may be configured to determine, detect, and/or measure spatial information of the one or more target vehicles 203A and 203B as the one or more target vehicles 203A and 203B approach the vehicle 102 from behind. The ECU 106 may be configured to determine the one or more target vehicles 203A and 203B are within range to relay a VEM based on a period of time between the one or more target vehicles 203A and 203B being a first distance from the source vehicle 201 (e.g., 50 feet, 100 feet, etc.) and the one or more target vehicles 203A and 203B being a second distance from the source vehicle 201 (e.g., 5 feet, 10 feet, etc.), for example. Accordingly, the ECU 106 may be configured to determine the one or more target vehicles 203A and 203B are within range as the one or more target vehicles 203A and 203B approach the source vehicle 201 (e.g., when the one or more target vehicles 203A and 203B are in the same lane as the source vehicle 201 or a lane adjacent to a current lane of the source vehicle 201) and/or pass the source vehicle 201 (e.g., when the one or more target vehicles 203A and 203B are in one or more lanes adjacent to a current lane of the source vehicle 201).

In one aspect, the source vehicle 201 and the target vehicles 203A and 203B may exchange relevant data, such as current battery level, current gas tank level, etc., via V2X connectivity. In the case that one of the target vehicles 203A and 203B has a low battery, low fuel, etc., the source vehicle 201 may opt out of sending the VEM to that vehicle. That way, the source vehicle 201 does not waste time sending the VEM to a vehicle that is at risk of not reaching its destination.

In one aspect, when the source vehicle 201 is experiencing the emergency, the ECU of the source vehicle 201 may cause the source vehicle 201 to enter into emergency mode. The emergency mode may cause the vehicle to go into battery save mode so as to not drain the vehicle's battery unnecessarily while waiting for emergency services to be contacted and arrive.

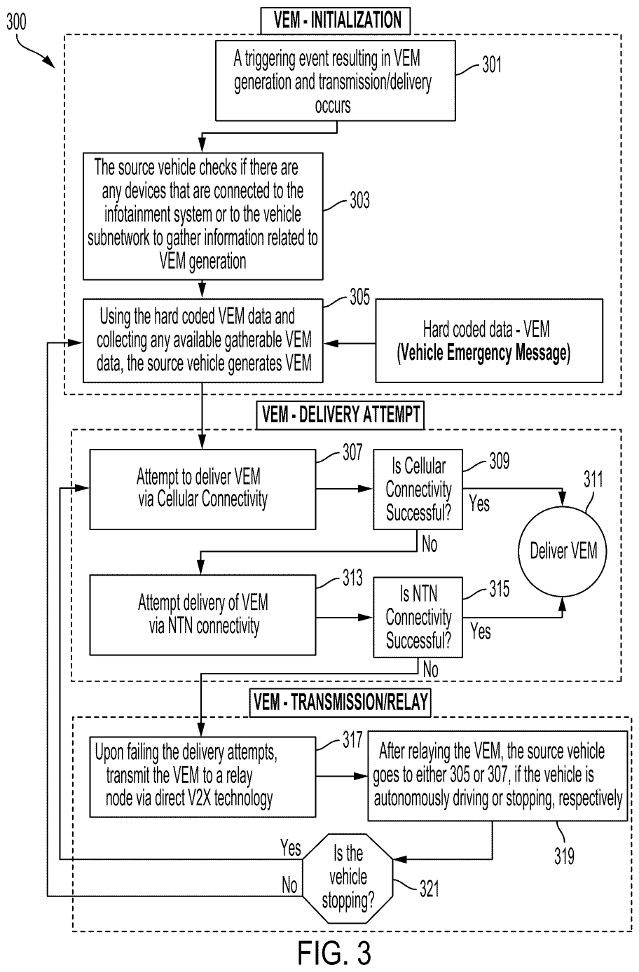

FIG. 3 is a flow diagram of an example process 300 using a source vehicle for the emergency message delivery system 100 of FIG. 1 where the source vehicle may generate and relay a VEM according to an aspect of the disclosure. The process 300 can be applied to any vehicle that is capable of any connectivity technology (e.g., V2X (e.g., DSRC, Long-Term Evolution (LTE) sidelink, 5G NR sidelink), TN, NTN).

At block 301, a triggering event, such as an emergency, resulting in VEM generation and transmission/delivery may occur. In one aspect, the driver may trigger the emergency manually due to one or more of following reasons: security violation in which case there is a threatening act against the driver or the car, such as burglary, breaking and entering, hijacking, etc., medical emergency for any of the passengers, vehicle malfunction (e.g., flat tire, broken transmission, etc.), or if lost or stuck. In another scenario, a medical emergency may occur. In some aspects, a medical emergency can be detected by the attention and wellbeing sensor(s) of the vehicle (e.g., driver monitoring sensors). In addition, a medical emergency notification can be received from any possible smart wearables of the passengers inside the vehicle.

Following the triggering event, at block 303, the source vehicle can check if there are any devices connected to the infotainment system or to the vehicle subnetwork to gather information related to VEM generation. The source vehicle may be the vehicle in which an emergency occasion occurs. In one aspect, the source vehicle may find a connected user device (e.g., driver's cell phone) and no available relevant data or information. In another aspect, the source vehicle may find a connected user device and one or more of relevant information of the following: last assigned Network ID of user phone, medical information or health data that is available for sharing with prior user consent (e.g. via health application), and/or cellphone number of the device for emergency services to contact later. In another aspect, the source vehicle may not find any device connected to the infotainment system and therefore cannot gather relevant information.

At block 305, using the VEM data and collecting any available gatherable VEM data, the source vehicle generates a VEM. The source vehicle then may proceed to attempt delivery of the VEM. In one aspect, the source vehicle can embed the following information to the VEM: the operation mode for current driving mode, current range, miles per gallon (MPG), or state of charge, any information gathered about the emergency, number of passengers, and, if available, the type and severity of the emergency.

In the case of an autonomous vehicle, the source vehicle may choose to stop the vehicle and may embed the available location information with direction of the vehicle and the time stamp. In another aspect, the source vehicle may autonomously navigate to the nearest emergency case location if possible (e.g., there is sufficient battery or fuel to successfully navigate to the destination). In this case, the source vehicle can embed the destination location together with the event location and the time stamps. In this way, emergency services can identify the intended destination of the vehicle in order to effectively deploy emergency services.

At block 307, the vehicle attempts delivery via TN Connectivity. In one aspect, the vehicle may have cellular connectivity technology and can attempt transmission of the VEM via cellular connectivity (e.g., eCall, ACN, E911, etc.). In another aspect, the vehicle may not have cellular connectivity technology but can use the connected mobile phone of the driver or passengers and may attempt to contact the emergency services via the mobile phone. In some aspects, the vehicle may contact emergency services via the infotainment system connected to the mobile phone of the driver or passengers. In another aspect, the vehicle may fail to establish cellular connectivity and therefore fail to deliver VEM via cellular connectivity.

At block 309, the vehicle may determine if cellular connectivity is successful. If yes (e.g., cellular connectivity is successful), at block 311, the vehicle delivers the VEM. Therefore, the VEM may be delivered to emergency services via cellular connectivity. At that point, delivery of the VEM is successful and therefore, the process may end. If no (e.g., cellular connectivity is unsuccessful), the process proceeds to block 313.

At block 313, the vehicle attempts delivery of VEM via NTN Connectivity. In one aspect, the vehicle may have NTN technology and can attempt VEM delivery via NTN connectivity. In another aspect, the vehicle may not have NTN technology but can attempt delivery using driver's phone connected to the infotainment system for emergency message delivery via NTN connectivity. In another aspect, the vehicle may fail to establish NTN connectivity and therefore fail to deliver VEM via NTN connectivity. At block 315, the vehicle determines if NTN connectivity is successful. If yes, at block 311, the vehicle may deliver the VEM. Therefore, the VEM may be delivered to emergency services via NTN connectivity. At that point, delivery of the VEM is successful and therefore, the process may end. If no, the process may proceed to block 317.

At block 317, upon failing the delivery attempts, the vehicle transmits the VEM to a relay node (e.g., another vehicle) via V2X technology. The transmission can be initiated via one or more V2X connectivity types from the vehicle, such as DSRC, ITS-G5, LTE-V2X Sidelink, 5G NR-V2X Sidelink, for the VEM to be relayed to the network, other vehicles, and/or emergency services.

At block 319, after relaying the VEM, the vehicle may proceed to either block 305 or block 307, if the vehicle is stopping or in an automated driving mode, respectively. Therefore, the vehicle may stay in the loop to either look for TN or NTN connectivity for delivery of the VEM or repeat transmission of the VEM using V2X for potential delivery through relay nodes. The loop may continue until there is successful delivery of the VEM. In one aspect, the vehicle may attempt to establish any type of connection with the network and deliver the VEM, either in block 305 or block 307. Therefore, by establishing a type of connection, the VEM delivery loop can be broken.

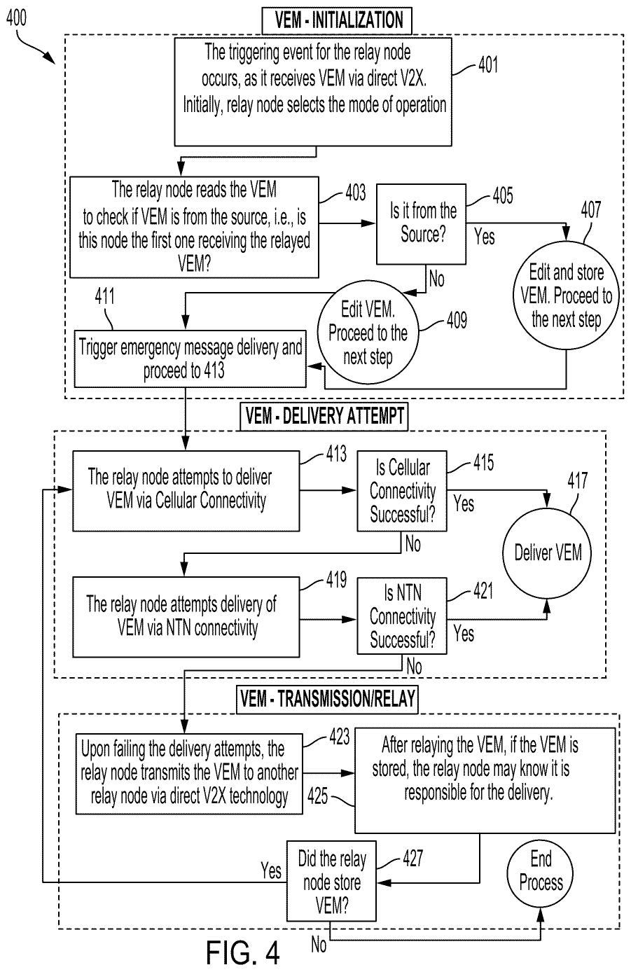

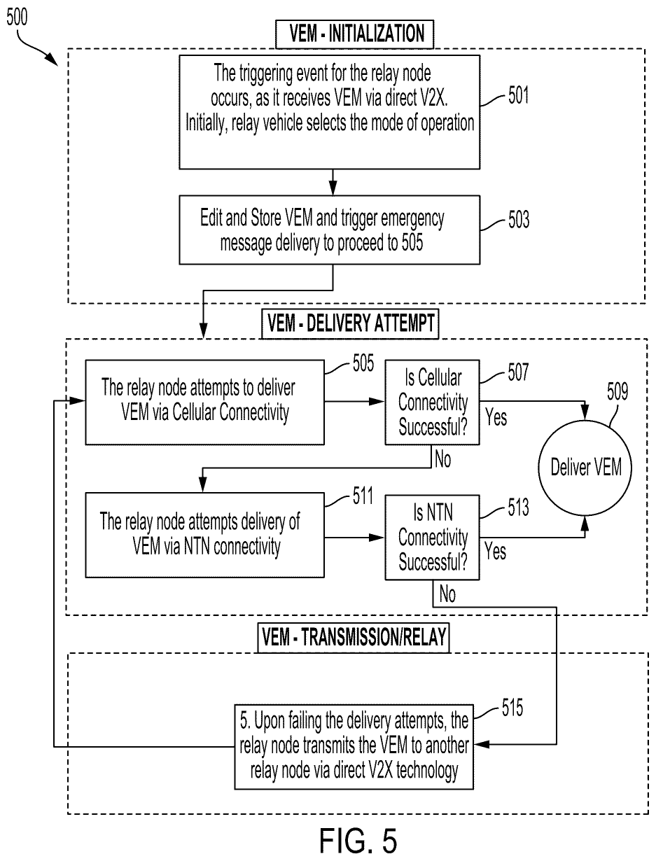

FIG. 4 is a flow diagram of an example process 400 using a relay node in low redundancy mode for the emergency message delivery system of FIG. 1 according to an aspect of the disclosure. A relay node may be a second vehicle including a network access device that can relay or deliver the VEM transmitted from the source vehicle to the network, another vehicle, or emergency services. There may be two modes for a relay node: (1) low redundancy mode where the VEM transmission rate is low, and the relay node may not stay in the loop (this avoids the message congestion at the emergency service end) (shown and described in FIGS. 4) and 2) high redundancy mode with more redundant delivery of VEM (shown and described in FIG. 5). The latter has a higher assurance for delivering the VEM.

At block 401, the triggering event for the relay node may occur, as the relay node receives the VEM via V2X. Initially, the relay node may read the VEM and choose the operation mode (e.g., low or high redundancy) accordingly. In one aspect, the relay node may read the VEM and decide to operate in low redundancy mode based on a configuration by the network. In one aspect, the relay node may decide to operate in low redundancy mode if the priority of emergency is below a priority threshold. The priority threshold may be associated with a congestion level of V2X (e.g., channel busy ratio). In one aspect, the relay node may decide to operate in low redundancy mode if a congestion level of V2X (e.g., channel busy ratio) is above a congestion threshold. The congestion threshold may be associated with the type and/or priority of the emergency.

At block 403, the relay node reads the VEM to check if VEM is from the source (e.g., the relay node checks if it is the first one receiving the transmitted VEM). In one aspect, the relay node may read that the VEM is sent by another relay node, therefore it can trigger the emergency message delivery directly and proceed to block 413. In another aspect, the relay node may read that the VEM is sent by the source vehicle therefore making it the first relay node in this relayed VEM delivery chain. Therefore, the relay node may edit the VEM so that the next node would know that the VEM is not from the source anymore and store the VEM to take the responsibility of delivering this emergency message.

In one aspect, the vehicle associated with the relay mode may identify the nearest emergency service. This way, the VEM can be transmitted to the closest emergency service to shorten the time it may take for emergency services to arrive at the source vehicle. The vehicle may identify the nearest emergency service via one or more sensors or location data.

At block 413, the relay node attempts delivery of the VEM via TN Connectivity. In one aspect, the relay node may have cellular connectivity technology and therefore, can attempt VEM delivery via cellular connectivity (e.g., eCall, ACN, E911, etc.). In another aspect, the relay node may not have cellular connectivity technology but can use the connected mobile phone of a driver or passenger and attempt to contact the emergency services. For example, the mobile phone may be connected to the vehicle via the infotainment system. In another aspect, the relay node may fail to establish cellular connectivity and therefore, fail to deliver the VEM via cellular connectivity. At block 415, the system determines if cellular connectivity is successful. If yes, at block 417, the relay node delivers the VEM. If no, the method proceeds to block 419.

At block 419, the relay node attempts delivery of VEM via NTN Connectivity. In one aspect, the relay node has NTN technology and attempts VEM delivery via NTN connectivity. In another aspect, the relay node may not have NTN technology but can attempt using the driver's (or passengers) mobile phone for emergency message delivery via NTN connectivity. For example, the mobile phone may be connected to the vehicle via the infotainment system. In another aspect, the relay node may fail to establish NTN connectivity and therefore fail to deliver VEM via NTN connectivity. At block 421, the system determines if NTN connectivity is successful. If yes, the relay node delivers the VEM. If no, the method proceeds to block 423.

At block 423, upon failing the delivery attempts, the relay node transmits the VEM to a different relay node via V2X technology. The different relay node may be another vehicle including a network access device configured to receive and transmit a VEM. The transmission can be initiated via one or more V2X connectivity types such as DSRC, ITS-G5, LTE-V2X Sidelink, 5G NR-V2X Sidelink, for the VEM to be relayed to the network, other vehicles, and/or emergency services.

At block 425, after relaying the VEM, if the VEM is stored, the relay node goes back to block 413 and may stay in the loop attempting connectivity until delivery of the VEM. At block 427, the system may determine if the relay node stored the VEM. If yes, the method proceeds back to block 413 and repeats the subsequent blocks until delivery of the VEM. In this case, the relay node may exit the loop by delivering the VEM itself after reaching coverage. If the relay node did not store the VEM, the method ends.

FIG. 5 is a flow diagram of a third example process 500 using a relay node in high redundancy mode for the emergency message delivery system of FIG. 1 according to an aspect of the disclosure. As a result of receiving a VEM via V2X connectivity, the relay node may follow the steps and uses in one or multiple of the aspects or embodiments described below.

At block 501, the triggering event for the relay node occurs, as the relay node receives a VEM via V2X. Initially, the relay node may read the VEM and choose the operation mode accordingly. In one aspect, the relay node may read the VEM and decide to operate in high redundancy mode based on a configuration by the network. In one aspect, the relay node may decide to operate in high redundancy mode if the priority of emergency is above a priority threshold. The priority threshold may be associated with a congestion level of V2X (e.g., channel busy ratio). In one aspect, the relay node may decide to operate in high redundancy mode if a congestion level of V2X (e.g., channel busy ratio) is below a congestion threshold. The congestion threshold may be associated with the type and/or priority of emergency.

At block 503, in high redundancy mode, the relay node may edit and directly store the VEM, and then proceed to block 505 by triggering the emergency message delivery.

At block 505, the relay node attempts delivery via TN Connectivity. In one aspect, the relay node may have cellular connectivity technology and attempt VEM delivery via cellular connectivity (e.g., eCall, ACN, E911, etc.). In another aspect, the relay node may not have cellular connectivity technology but can use the connected mobile phone of a driver or passenger and attempt to contact the emergency services. For example, the mobile phone may be connected to the vehicle via the infotainment system. In another aspect, the relay node may fail to establish cellular connectivity and therefore fail to deliver VEM via cellular connectivity.

At block 507, the vehicle may determine if cellular connectivity is successful. If yes (e.g., cellular connectivity is successful), at block 509, the vehicle delivers the VEM. Therefore, the VEM may be delivered to emergency services via cellular connectivity. At that point, delivery of the VEM is successful and therefore, the method may end. If no (e.g., cellular connectivity is unsuccessful), the method proceeds to block 511.

At block 511, the relay node attempts delivery of VEM via NTN Connectivity. In one aspect, the relay node may have NTN technology and can attempt VEM delivery via NTN connectivity. In another aspect, the relay node may not have NTN technology but can attempt using the driver's (or passenger's) phone for emergency message delivery via NTN connectivity. For example, the phone may be connected to the vehicle via the infotainment system. In another aspect, the relay node may fail to establish NTN connectivity and therefore, fail to deliver VEM via NTN connectivity.

At block 515, the vehicle may determine if NTN connectivity is successful. If yes (e.g., NTN connectivity is successful), at block 509, the vehicle delivers the VEM. Therefore, the VEM may be delivered to emergency services via NTN connectivity. At that point, delivery of the VEM is successful and therefore, the method may end. If no (e.g., NTN connectivity is unsuccessful), the method proceeds to block 515.

At block 515, upon failing the delivery attempts, the relay node transmits the VEM to a different relay node via V2X technology. The different relay node may be another vehicle including a network access device configured to receive and transmit a VEM. The transmission can be initiated via one or more V2X connectivity types such as DSRC, ITS-G5, LTE-V2X Sidelink, 5G NR-V2X Sidelink, for the VEM to be relayed to the network, other vehicles, and/or emergency services.

After relaying the VEM, the relay node in high redundancy mode may directly go back to block 505 and stay in the loop until delivery of the message.

Exemplary aspects and embodiments of the invention have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A vehicle emergency message delivery system, comprising:
a first network access device of a first vehicle configured to transmit and receive a vehicle emergency message;
a second network access device of a second vehicle configured to transmit and receive the vehicle emergency message; and
an electronic control unit (ECU) electrically connected to the first network access device and configured to:
receive a triggering signal indicating an emergency has occurred;
in response to receiving the triggering signal, generate a vehicle emergency message having information about the first vehicle and passengers including a location of the first vehicle, current status of the vehicle emergency message, and vehicle identification data about the first vehicle;
transmit the vehicle emergency message to emergency services via cellular connectivity;
transmit the vehicle emergency message to emergency services via satellite connectivity when the transmission of the vehicle emergency message via cellular connectivity fails;
when both transmissions have failed, transmit the vehicle emergency message to the second network access device of the second vehicle via the first network access device to allow the second network access device to deliver the vehicle emergency message to emergency services using satellite or cellular connectivity; and
receive confirmation of delivery of the vehicle emergency message to emergency services from the second vehicle.

2. The system of claim 1, wherein the ECU is further configured to:
control the first vehicle to autonomously come to a stop when the triggering signal indicating an emergency has occurred is received.

3. The system of claim 1, wherein the second network access device transmits the vehicle emergency message to a third network access device of a third vehicle via the second network access device when transmission using satellite or cellular connectivity has failed.

4. The system of claim 1, wherein the emergency comprises one or more of burglary, medical, breaking and entering, hijacking, vehicle malfunction, or flat tire.

5. The system of claim 1, further comprising one or more sensors coupled to the first vehicle configured to detect the information about the first vehicle and passengers, wherein to generate the vehicle emergency message, the ECU is further configured to:
identify, via the one or more sensors, the information about the first vehicle and passengers; and
embed the information about the first vehicle and passengers in the vehicle emergency message.

6. The system of claim 1, wherein the information about the first vehicle and passengers comprises one or more of location of the first vehicle, current driving mode of the first vehicle, type of emergency occurring, current range, current miles per gallon, state of vehicle charge, is the first vehicle stopping, is the first vehicle en route to a destination, first vehicle identification number, supported connectivity capabilities of the first vehicle, number of passengers, medical data of passengers, or number of passenger cell phone.

7. The system of claim 1, wherein the current status of the vehicle emergency message comprises an indication that the vehicle emergency message is from the first vehicle and the number of hops from the first vehicle.

8. The system of claim 1, wherein the vehicle identification data about the first vehicle comprises one or more of first vehicle brand, first vehicle model, first vehicle color, first vehicle identification number, or automated driving capability.

9. The system of claim 1, wherein transmission via cellular connectivity is performed prior to transmission via satellite connectivity.

10. A method for generating and transmitting a vehicle emergency message, the method comprising:
receiving a triggering signal indicating an emergency has occurred;
in response to receiving the triggering signal, generating a vehicle emergency message having information about a first vehicle and passengers including a location of the first vehicle, current status of the vehicle emergency message, and vehicle identification data about the first vehicle;
transmitting the vehicle emergency message to emergency services via cellular connectivity;
transmitting the vehicle emergency message to emergency services via satellite connectivity when the transmission of the vehicle emergency message via cellular connectivity fails;
when both transmissions have failed, transmitting the vehicle emergency message to a second network access device of a second vehicle via a first network access device to allow the second network access device to deliver the vehicle emergency message to emergency services using satellite or cellular connectivity; and
receiving confirmation of delivery of the vehicle emergency message to emergency services from the second vehicle.

11. The method of claim 10, further comprising:
controlling the first vehicle to autonomously come to a stop when the triggering signal indicating an emergency has occurred is received.

12. The method of claim 10, wherein the second network access device transmits the vehicle emergency message to a third network access device of a third vehicle via the second network access device when transmission using satellite or cellular connectivity has failed.

13. The method of claim 10, wherein the emergency comprises one or more of burglary, medical, breaking and entering, hijacking, vehicle malfunction, or flat tire.

14. The method of claim 10, wherein generating the vehicle emergency message comprises:
identifying, via one or more sensors coupled to the first vehicle, the information about the first vehicle and passengers; and
embedding the information about the first vehicle and passengers in the vehicle emergency message.

15. The method of claim 10, wherein the information about the first vehicle and passengers comprises one or more of location of the first vehicle, current driving mode of the first vehicle, type of emergency occurring, current range, current miles per gallon, state of first vehicle charge, is the first vehicle stopping, is the first vehicle en route to a destination, first vehicle identification number, supported connectivity capabilities of the first vehicle, number of passengers, medical data of passengers, or number of passenger cell phone.

16. The method of claim 10, wherein the current status of the vehicle emergency message comprises an indication that the vehicle emergency message is from the first vehicle and the number of hops from the first vehicle.

17. The method of claim 10, wherein the vehicle identification data about the first vehicle comprises one or more of first vehicle brand, first vehicle model, first vehicle color, first vehicle identification number, or automated driving capability.

18. The method of claim 10, wherein transmission via cellular connectivity is performed prior to transmission via satellite connectivity.

19. A vehicle including a system for generating and transmitting a vehicle emergency message, the vehicle comprising:
a first network access device configured to transmit and receive a vehicle emergency message; and
an electronic control unit (ECU) electrically connected to the first network access device and configured to:
receive a triggering signal indicating an emergency has occurred;
in response to receiving the triggering signal, generate the vehicle emergency message having information about the vehicle and passengers including a location of the vehicle, current status of the vehicle emergency message, and vehicle identification data about the vehicle;
transmit the vehicle emergency message to emergency services via cellular connectivity;
transmit the vehicle emergency message to emergency services via satellite connectivity when the transmission of the vehicle emergency message via cellular connectivity fails;
when both transmissions have failed, transmit the vehicle emergency message to a second network access device of a second vehicle via the first network access device to allow the second network access device to deliver the vehicle emergency message to emergency services using satellite or cellular connectivity; and
receive confirmation of delivery of the vehicle emergency message to emergency services from the second vehicle.

20. The vehicle of claim 19, wherein the first network access device transmits the vehicle emergency message to a third network access device of a third vehicle when transmission using satellite or cellular connectivity has failed.
